(19) United States
(12) Patent Application Publication
(10) Pub. No.: US 2018/0044575 A1
(43) Pub. Date: Feb. 15, 2018

(54) MATERIALS AND THEIR CHARACTERIZATION IN HETEROGENEOUS PROPPANT PLACEMENT

(71) Applicant: SCHLUMBERGER TECHNOLOGY CORPORATION, Sugar Land, TX (US)

(72) Inventors: Fedor Nikolaevich LITVINETS, Biysk (RU); Sergey Mikhailovich MAKARYCHEV-MIKHAILOV, St. Petersburg (RU); Danil Sergeevich PANTSURKIN, Novosibirsk (RU); Geza HORVATH SZABO, Sugar Land, TX (US); Mohan Kanaka Raju PANGA, Katy, TX (US); Denis Yurievich EMELYANOV, Novosibirsk (RU)

(21) Appl. No.: 15/555,636

(22) PCT Filed: Mar. 3, 2015
(86) PCT No.: PCT/RU2015/000130

§ 371 Date: Sep. 5, 2017

(51) Int. Cl. C09K 8/80; E21B 43/267; E21B 47/00

(52) U.S. Cl. CPC C09K 8/80; E21B 47/00; E21B 43/267

(57) ABSTRACT

Methods of selection of materials that are used as a proppant for HPP fracturing treatments, also the procedure for the design of HPP treatment.

### BACKGROUND

Hydraulic fracturing includes injecting a fluid at high volume or high pressure or both to facilitate flow in a fracture in a subterranean formation. Fluid is mixed with propping agent (proppant) that keeps a fracture open when injection is stopped and fluid leaks off into formation or flows back on the surface. By this means a homogeneous proppant pack is created. Hereinafter this type of the treatment is referred as conventional fracturing treatment.

Heterogeneous proppant placement (HPP) is an additional approach for hydraulic fracturing. Heterogeneous proppant packs, also referred to as proppant pillars, prevent fracture closure and provide highly conductive channels around pillars serving as flow path for hydrocarbons.

Fracture conductivity is a parameter that relates to a wellbore's production rate. For a fracture with a conventional fracturing treatment, conductivity is directly related to the conductivity of the proppant pack and thus to permeability of the proppant used for the treatment.

### SUMMARY

Herein, we discuss methods of materials selection to be used as a proppant for HPP fracturing treatments. We also discuss a procedure for designing a HPP treatment.

### FIGURES

FIG. 1 is an example of a pumping schedule.

FIG. 2 is a schematic diagram of horizontal and gravity forces on a proppant pack under stress: a—vertical geometry, b—horizontal geometry. Gravity is acting along Z axis.

FIG. 3 is a plot of drag and gravity forces as a function of fluid velocity.

FIG. 4 is a plot of gravity force as a function of particle diameter.

FIG. 5 is a schematic of a compaction test.

FIG. 6 is a plot of porosity vs. stress.

FIG. 7 is a graphical representation of sample height reverse calculation.

FIG. 8 is a schematic representation of proppant loading for proppant pack erosion testing. The viewpoint is co-directional to direction of applied stress.

FIG. 9 is a schematic representation of a proppant loading example for proppant pack erosion testing. The viewpoint is co-directional to direction of applied stress.

### DETAILED DESCRIPTION

For a fracture with HPP, conductivity is determined by geometry of the channels created and does not depend on proppant permeability. This phenomenon changes requirements for the proppant in use. Also for HPP fracturing treatments it gives possibility to use materials as the proppant that are not suitable for conventional fracturing treatments.

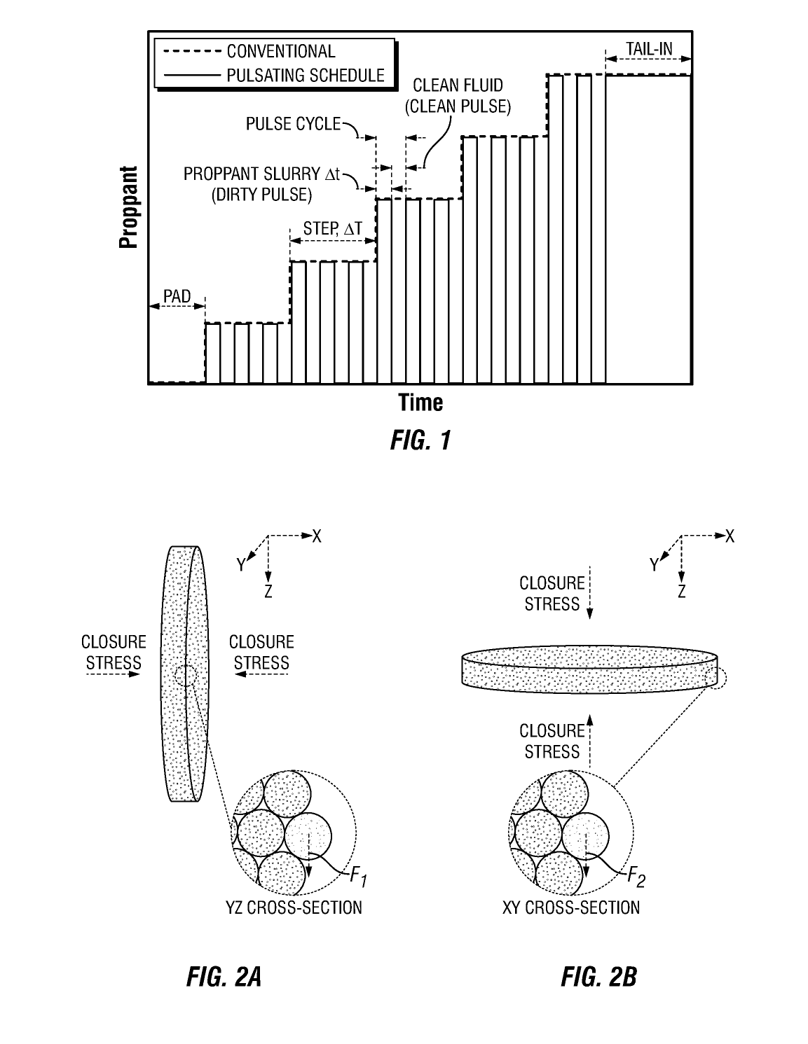

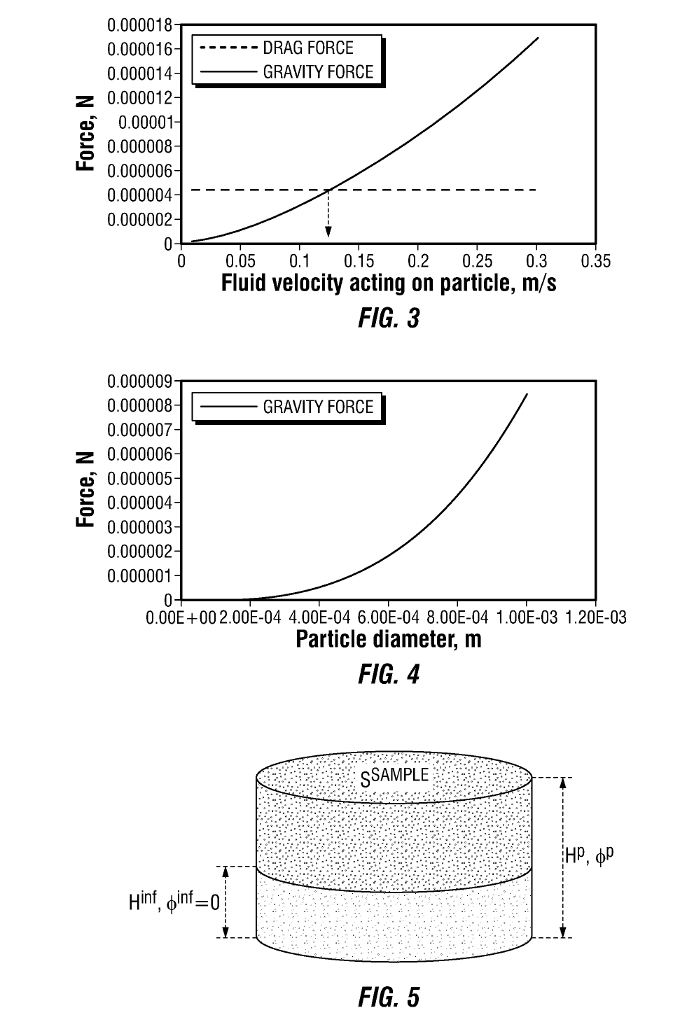

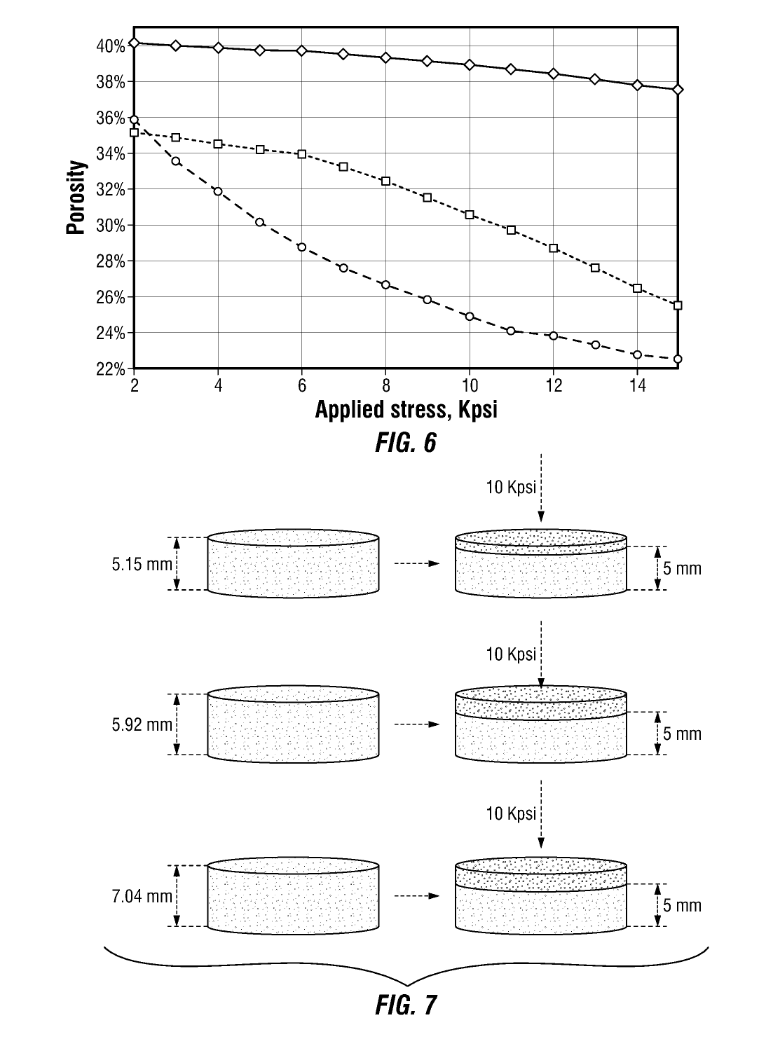

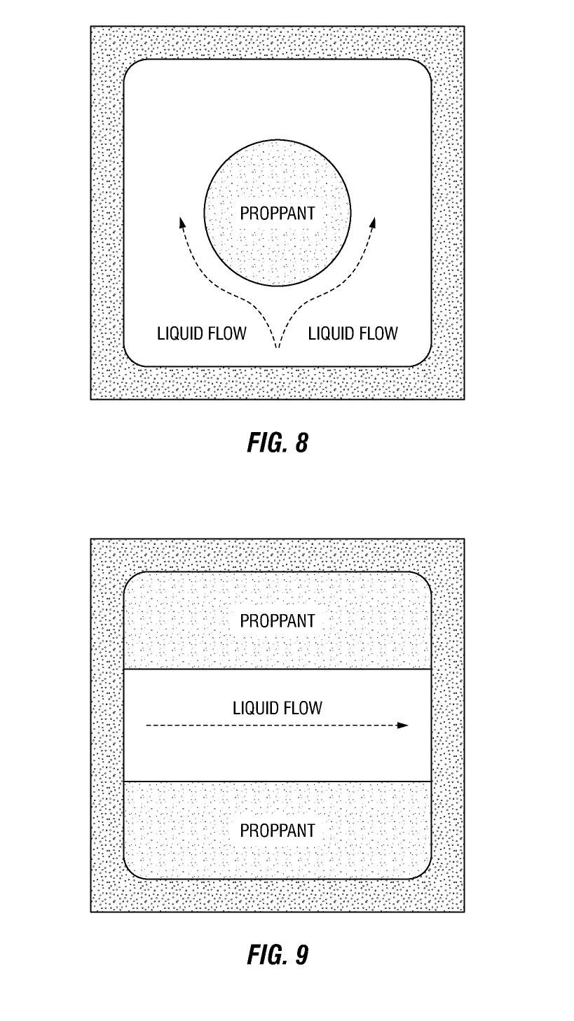

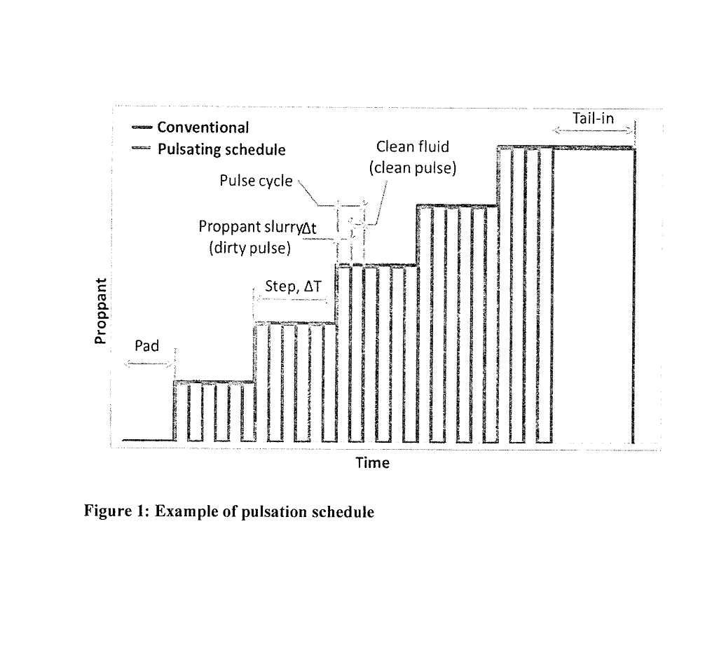

Some embodiments pump slugs of a fluid with different rheological and/or other properties. FIG. 1 shows example of a pumping schedule. The first step is a proppant free step, called PAD, which aims to initiate fracture and define its geometry. After that a number of proppant steps are pumped usually with increasing proppant concentration ω. The proppant steps are pumped in cycles, with every cycle consisting of pulses with varied proppant concentration, in a non-limiting example a clean fluid pulse (clean pulse) and a proppant-laden slurry pulse (proppant pulse) of the same or different duration. The proppant concentration in proppant slurry pulses is usually, but not necessarily, kept the same for every step. The last proppant step, called Tail-In, is pumped without pulses and serves as a connection between the channeled fracture and a wellbore. When fracture is closed proppant pulses create proppant pillars and clean pulses create channels around pillars.

Conductivity of the HPP fracture is much higher than that of conventional one provided that the channels remain open. Conductivity of HPP fracture C_{ch} in case of open channels will be referred further as “Infinite” and can be estimated by the following equation:

C_{ch}=w³/12 eq. 1

Here w is a minimum distance between fracture walls. As can be seen fracture conductivity does not depend on permeability of the proppant that is used for pillars creation. Hence, material used during pulsing steps can be qualified as a proppant for HPP hydraulic fracturing treatments regardless of proppant pack permeability.

Although Infinite conductivity of HPP fracture is independent of proppant pack permeability, it strongly depends on whether channels are open or not. The criterion of open-close channels is correlated with distance L between pillars inside the fracture. Channels are considered open if the length L does not exceed critical value L_{cr}. Critical length can be estimated from the following equation:

L_{cr}=L_{cr}(P_{cl},E, v, w_{hyd}, H, D, H_{fr}, Aₚ) eq. 2

Here closure stress (P_{cl}), Young modulus (E) and Poisson ratio (v) are formation geomechanical properties; hydraulic width (w_{hyd}) and fracture height (H_{fr}) are fracture geometrical properties; and pillar height (H), characteristic length of the pillar (D) and propping ratio (Aₚ) are pillar geometrical properties.

Formation geomechanical properties are inherent properties of the formation. Fracture and pillar geometrical properties can be to some extent controlled by the treatment design (pumping rate, fluid rheology, etc.). Pillar geometrical properties can be controlled by treatment design and selection of material used as proppant. With other parameters being fixed, the critical distance L_{cr} depends on pillar geometrical properties.

Pillar height H depends on proppant concentration in proppant pulses ω and pillars compaction (porosity of proppant pack, φ^{p}) under exerted stress. Characteristic length D in non-limiting example of a pillar round in cross section is the pillar diameter. Propping ratio Aₚ is defined as ratio between propped and unpropped surface area of a fracture face.

Propping ratio can be calculated as

Aₚ=Vₚᵣ/V_{cl}*Disp*Squash* eq. 3

### Erosion

Here Vₚᵣ is volume of proppant slug, V_{cl} is volume of clean slug, Disp is coefficient due to proppant slug dispersion or consolidation from pumping start to fracture closure start. Squash is coefficient due to pillar squashing during fracture closure. Erosion is a coefficient due to pillar erosion.

Non-limiting example of Disp, Squash and Erosion definition is following: Disp=V′ₚᵣ/Vₚᵣ; Squash=S_{S}/S and Erosion=S_{E}/S_{S}. Here V′ₚᵣ is volume of proppant slug after dispersion; S_{S} is the pillar area after squashing/spreading; S_{E} is the pillar area after the “erosion time”, ET. The ET is as a period defined from the instant the pillar is exposed to the fluid flow until the time after which further erosion is negligible on the scale of the original area of pillar; This ET can only be introduced for a limited set of flow conditions. Typically, it can be introduced for low density/viscosity fluids in the low linear flow velocity ranges. For flow conditions out of this range, the propping ratio will be time dependent. S is a surface area of placed pillar exposed neither to squashing nor to erosion. It should be accounted that erosion usually occurs only after squashing, which explains form of Squash and Erosion coefficients.

Herein, we provide a workflow of measuring material properties critical for HPP treatments, selection of appropriate material, and creating treatment schedule for HPP treatments.

### Embodiment 1

### Method of Material Parameters Determination Required to Estimate Pillar Geometrical Properties.

HPP treatment with a given material is to be designed in such a way that channels remain open after fracture closure. To achieve this, pillar geometrical properties H, D, Aₚ are to be determined. Pillar geometrical properties can be calculated provided that material critical parameters are known.

The workflow for the material parameters determination is provided below. The following assumptions have been taken into account in order to simplify the said workflow:

(asmp. i) The squashing/spreading caused by fracture closure is negligible for large enough pillars. Hence Squash=1.

(asmp. ii) Coefficient Disp does not depend on the type of material used as a proppant. If viscosity of carrier fluid is above 200 cp at 170 1/s and fibers are added to the fluid then we can assume that Disp=1.

1. Absolute density ρ of material should be measured.

2. Erosion rate of proppant should be measured at a testing fluid linear velocity, which can be derived from the produced fluid properties and its actual velocity in the fracture. An approach of measuring erosion rate of proppant pack is discussed in more detail below.
2.1. The linear velocity of testing fluid should be set based on the produced fluid linear velocity. Produced fluid linear velocity at bottom-hole conditions should be calculated based on fractures geometrical properties, (predicted/forecasted/average on the offsets basis) production rate, and propping ratio. An approach of calculating produced fluid and corresponding testing fluid linear velocities is discussed in more detail below.
2.2. Effective stress for erosion testing should be calculated based on formation stress and propping ratio.
2.3. In steps 2.1 and 2.2 for calculation of propping ratio by eq. 3 it should be assumed Erosion=1.

3. One should calculate Erosion coefficient based on erosion rate measured in 2.

4. Propping ratio Aₚ is calculated using eq. 3 and assumptions i and ii.

5. Effective stress on the proppant pack is calculated based on formation stress and propping ratio.

6. Porosity at effective stress (φ^{p}) calculated in 5 should be measured.

Following parameters are provided as result of the experimental procedures listed above: ρ, Erosion, φ^{p}. Knowing these values for a particular proppant in combination with formation geomechanical properties and fracture geometrical properties the geometrical properties of pillars can be calculated, and, thus, the treatment design can be elaborated.

### Embodiment 2

### Method of HPP Treatment Design Creation Based on Pillar Parameters Determined in the Experimental Procedures Described Above.

Parameters ρ, Erosion, φ^{p} can be used as input parameters to fracture design software such as the software services including MANGROVE™ commercially available from Schlumberger Technology Corporation of Sugar Land, Tex. to calculate pillar geometrical properties D, H and Aₚ. Then, these properties can be used to create the HPP treatment design.

Some embodiments substitute proppant material in HPP treatment design that was validated by production results in a particular formation. To substitute propping agent currently used (proppant 1) with new propping agent (proppant 2) both proppants have to be tested according to the procedure listed above. Then, there are 2 options to obtain the treatment design: using reference proppant or direct modeling.

If reference proppant approach is used, then new HPP treatment design with use of proppant 2 is created in which all the treatment parameters remain the same except for proppant concentration. Proppant concentration is:

ω₂=ω₂(ρ₁, ρ₂, φ₁^{p}, φ₂^{p}, ω₁) eq. 4

Here ω is concentration of propping material in the slug in PPA units, φ^{p} is proppant pack porosity (i.e. ratio of the void space to the total volume of the pillar) at a certain stress, ρ is absolute density of proppant, indexes ₁ and ₂ correspond to materials 1 and 2. One should note that φ^{p} is a function of effective stress (stress on the proppant pack), which in turn is function of propping ratio and the closure stress; by these means Disp, Squash and Erosion coefficients are implicitly included in eq. 4.

For a direct modeling approach, first the treatment design is created using proppant 1. Then, results of this design (examples include, but not limited to fracture conductivity, width, half-length and open channels flag) are used as design objectives to design treatment using proppant 2.

Example workflow for the proppant substitution using fracture design software for the wells where no erosion is expected during production is the following:

1. Samples of both proppant 1 and proppant 2 are sent to the lab;

2. Lab tests are performed to measure proppant porosity vs. stress, critical erosion velocity (at which pillar erosion starts), proppant absolute density, proppant mesh size distribution, proppant mean diameter, proppant bulk density;

3. Test results are provided to the field in the following format:
3.1 Proppant porosity vs. stress is fitted by a 3^{rd} order polynomial. The resulted 4 coefficients of the polynom are provided;
3.2 Critical erosion velocity is provided as a number;
3.3 Proppant absolute density is provided as a number;
3.4 Proppant mesh size is provided as 2 numbers characterizing minimum and maximum mesh size
3.5 Proppant bulk density is provided as a number;

4. Field user prepares the treatment design in the fracture design software using proppant 1.

5. Field user opens the prepared design and enters abovementioned test results for both proppants into the fracture design software. All other proppant parameters as Non-Darcy flow coefficients, proppant friction coefficients, permeability vs. stress etc. are taken from the database supplied with the fracture design software;

6. Field user selects one of two options for proppant substitution:
6.1 Using reference proppant:
   6.1.1 User selects which proppant is used as reference and which proppant is a substitution;
   6.1.2 User executes the fracture design;
   6.1.3 As a result, new treatment schedule is generated with proppant 2. This schedule results in exactly the same fracture and channels geometry as conventional design;
6.2 Direct modeling:
   6.2.1 User substitutes the proppant 1 with proppant 2 in the treatment schedule;
   6.2.2 User executes the fracture design;
   6.2.3 User compares the resulted fracture conductivity, width, length and open channels flag with the corresponding results of conventional design;
   6.2.4 If resulted fracture conductivity, width or length are decreased after substitution and/or channels became closed, than user changes the schedule based on his experience and general fracture and other design rules to obtain better results. For example, the user may change PPA or length of some stages, change PAD volume, change pulse duration etc.
   6.2.5 Steps 6.2.2-6.2.4 are repeated until the resulted fracture conductivity, width, length are the same or higher than for conventional design, or until they satisfy criteria set by the user. Also, all channels should be open.

7. As a result, the user obtains a fracture design using proppant 2 and also recommended maximum production/flowback rate for particular well. If the treatment will be pumped as per this design and the recommended maximum production rate will not be exceeded during the well lifetime than the well production should not be compromised by the proppant substitution.

### Embodiment 3

### Alternative Proppants for HPP Treatment

Non-ISO proppants. Examples include river sand; soil excavated close to the well site; Frac-sands and ceramic proppant that do not meet ISO specification (such as standards ISO 13503-2 and ISO 13503-5). Using of non-ISO material for conventional fracturing will result in low conductivity of the fracture. For HPP fracturing treatment given material still can be used as proppant even if it does not meet ISO criteria in such parameters as permeability, grain size distribution, and resistance to crush. The material size has to be small enough to provide proppant admittance to the fracture.

Residuals of construction and other industrial processes. Examples are glass, set cement, bricks, marble, concrete, mortar, masonry, and drilling cuttings. Such solid materials after grinding can also be considered as proppant if can be pumped and form pillars of desired geometrical properties under bottomhole conditions. Some of these materials can be categorized as industrial byproduct.

Material with selected transport properties. Generally, the lower the mesh size and the lower the density of proppant material are the better transport properties that material has. In many cases, a requirement for high proppant permeability contradicts the requirements for good proppant transport. To achieve required proppant pack conductivity using of high mesh size (e.g. 20/40) proppant with high density (e.g. 3.2 g/cm³) is often required. Since conductivity of HPP fracture does not depend on proppant permeability, one can intentionally use material with relatively low mesh size (e.g. 40/70) and low density (e.g. 2.6 g/cm³). That will help to deliver proppant further towards the tip of the fracture achieving longer propped fracture half-length. Longer propped fracture half-length, in turn, will lead to increased production of the well treated.

Measuring Pack Settling

Conductivity of a HPP fracture is much higher than that of the conventional one while the flow passages for hydrocarbons (channels) remain open. This is so until the distance between pillars inside the fracture exceeds a critical length. Exceeding this length leads to channel closure and drastic drop of HPP fracture conductivity. Thus, change of the pillar/channel geometry due to the settling of proppant pillars during or after the treatment can affect fracture conductivity. Settling during treatment and before the fracture closes on proppant is different from settling after fracture closure. After fracture closure, there is a formation closure stress which compresses the pillar and creates friction force which acts against gravity force and can, therefore, prevent settling. In the case of HPP treated fractures, settling of proppant pillars in the formation might have a drastic impact on fracture conductivity and, therefore, on well production. Thus measurement of settling (especially under stress and at formation temperature) and characterization of its influence on well production is meaningful for HPP treated wells.

One technique to study settling of the proppant pillar uses a vertically aligned cell where a vertical dimension is high enough to allow proppant to settle under the force of gravity. Also, to apply stress to the pillar in such configuration, equipment which can apply force in the horizontal direction is needed.

Herein we discuss a technique of measurement of proppant settling which can be applied to heterogeneous proppant packs. Embodiments include modeling the force of gravity by another force acting in the horizontal direction which will allow using a horizontally aligned cell and equipment applying force in a vertical direction which is more elegant.

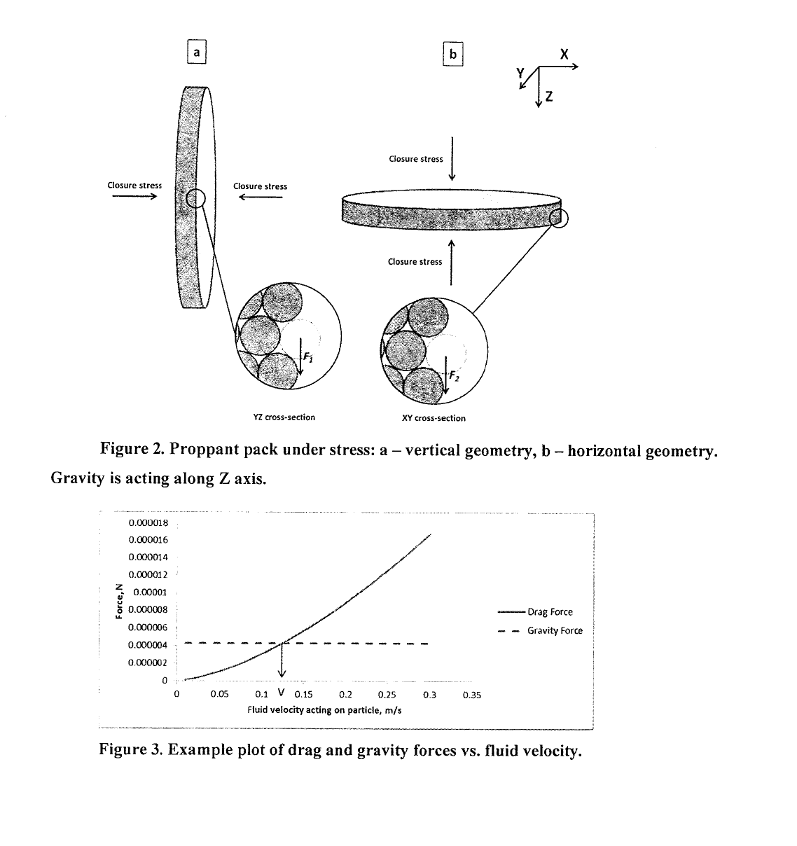

Embodiments test proppant/proppant pack sedimentation in horizontal geometry, instead of vertical geometry of the real fracture. FIG. 2 provides an illustration.

This is influenced by the following factors:
While vertical geometry is natural for the real fracture, establishing testing equipment, methodology and associated procedures is non-trivial, time consuming and expensive task.
Horizontal geometry is common for industry and is easily accessible.
Considerable amount of data is already collected (inside SLB) for proppant pack's stability under various conditions in horizontal geometry.

The main principles of this approach include the following:
Superposition of gravity and buoyancy forces acting on a proppant particle (F_1 FIG. 2, for simplicity hereinafter referred as gravity force) is substituted by equivalent model force (F_2 FIG. 2), e.g. drag force of the fluid.
Force of gravity in neglected in horizontal geometry because particles are stockpiled on each other, and physically constrained by the cell bottom. The contribution to the friction force because of particles interactions under gravity should also be neglected, because gravitational force is negligibly low comparing to the applied stress. This has to be achieved by test conditions.
Friction force between particles preventing particle detachment in both “a” and “b” cases, as shown on FIG. 2, assumed to be the same. This has to be achieved by test conditions.

Experimental Considerations.

The drag force of the fluid is used to model gravity. Testing methodology is analogous to characterizing erosion rate of proppant pack, described in more detail below. However, several points have to be taken into account:

Test can be performed both in “pillar” and “channel” configuration.

The goal of the experiment is not to measure sample erosion, but to test its sedimentation. Flow rate, sample and cell dimensions have to be adjusted to correctly simulate forces, acting on the proppant pack in vertical geometry. Drag force is increasing with linear velocity of the fluid and it is possible to find the velocity at which drag force acting on a particle is equal to gravity force acting on the same particle (velocity V in FIG. 3).

If the sample erosion occurs (and corresponding changes in the sample and cell dimensions), then the flow rate has to be increased respectively to ensure that the drag force of the fluid is matching the forces acting on the proppant pack in case of vertical geometry.

Experimental conditions should be selected to be as close as possible to the conditions of a real fracture and real proppant pack. This might include but not limited to:
Stress exerted on the proppant pack (mandatory).
Initial and resulting sample thickness (strongly recommended).
Temperature.
Physical properties of the surfaces, between which the sample is compressed (introduction of formation cores insertions to the testing cell is recommended).
Dimension (area) of the sample and the cell should be as large as possible. It is recommended to avoid testing samples with at least one minimal linear dimension (width or length) less than 10 cm.
Initial (at the moment when the proppant pack is placed in the fracture) and resulting (at any time point of interest) proppant pack formulation; including fluid, additives and proppant.
Magnetic field is used to model gravity. In such case particle detachment will be caused by magnetic force. Such force is more suitable for the reason it is a body force as well as gravitational force. However, such approach will require significant changes/upgrades of testing equipment, which include but not limited to: equipment and cell have to manufactured of nonmagnetic material, proppant for testing has to be magnetic in addition having the same properties as proppant to be placed into fracture (density, surface texture, crush resistance, etc.), source of magnetic field has to installed, etc.
Electrostatic force can be used in the way similar to magnetic force. This will also require modifications analogous to modifications mentioned for magnetic force.

Results Implementation:

Sedimentation impact. If model force (e.g. drag force) is set to match forces acting on the pack in vertical geometry it can be determined, whether sedimentation is an issue or not. Indicator of the fact that sedimentation has no impact on proppant is no continuous pillar destruction at constant model force. It should be noted, that the outer rim border of the proppant pack is formed with unconsolidated (free) proppant, which will be washed out at minimal force applied (e.g. minimal flow rates if drag force is used).

Threshold stress on the proppant pack to prevent sedimentation. The operation mentioned above can be repeated for different stresses on the pack to estimate minimal stress at which sedimentation is not an issue. The minimal stress value is important to design a fluid in order to maintain viscosity for a sufficient period of time. Basically, sedimentation has to be prevented by fluid viscosity until the stress on the pact increases higher than threshold stress. Threshold not necessary corresponds to the formation closure stress, and proppant pack stability might be reached earlier.

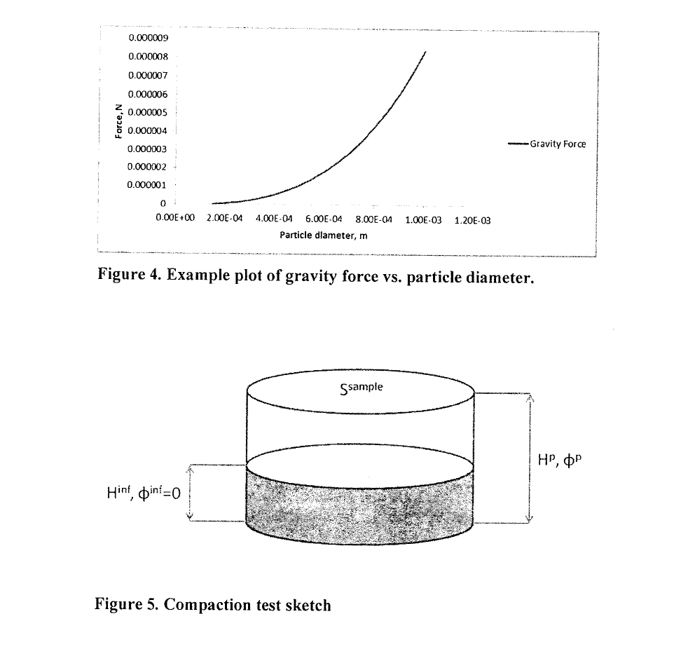

Proppant grain size. The impact of gravity is proportional to the linear dimension of the proppant grain in magnitude of three (FIG. 4). Thus, the impact of gravity can be mitigated by decreasing proppant grain size. To evaluate appropriate proppant mesh size several experiments with proppant of different mesh size should be performed as described above at a corresponding model force.

Compaction Test

The overall performance of an HPP treated fracture directly depends on geometry of the proppant pack created: diameter and height of the pillars, and distance between them beside the rock properties. It is assumed that diameter and distance between pillars is determined by volumes of proppant and clean pulses during the treatments. The height of proppant pack depends on the concentration and physical properties of the proppant pumped. The set of proppant properties affecting proppant pack height includes but not limited to: crush resistance, grain size distribution, roundness and sphericity, amount of non-ceramic (non-silica) content, proppant grain porosity, mechanical properties of the propping material (Poisson ratio, Young's modulus), crystallinity and uniformity of each grain. Most importantly the pack height is dependent on the stress too. Combining these properties in the analytical approach seems to be non-trivial and tedious task. That is why a simple, reliable and efficient procedure for measuring proppant pack height is required.

Proppant pack height is registered in ISO conductivity measurements (ISO 13503-5). The compaction test procedure discussed herein is related to ISO crush test (ISO 13503-2). The ISO crush test itself (without modifications suggested below) cannot provide data on proppant pack height.

In an HPP treated fracture, the proppant pack is usually exposed to the effective stress greater than that for homogeneous proppant pack. Under such high stress, proppant crushing will most likely occur and the height of HPP proppant pack will be reduced. Reduction of the pack height will lead to a decrease of channels cross-section (or to the channel closure in the worst case) and will compromise well production (or even reduce well production rate to that of untreated formation in the worst case).

Embodiments herein measure a dimensionless quantity of the proppant pack height, which can be scaled up to proppant pack of realistic size. Scaling up can be done for both homogeneous and heterogeneous proppant. However, to scale up experimental results to a realistic heterogeneous proppant pack, the pack dimensions should be large enough (it is suggested, that procedure can be scaled up to a proppant pillar which not less than 1 meter in diameter).

Implementation of such measurement includes but is not limited to: comparison of proppant performance; modeling implementation (general understanding of hydraulic fracturing and proppant pack behavior under formation stress); software implementation (more reliable and realistic job design; proppant substitution design)

One embodiment of the workflow for proppant pack height measurement procedure is as follows:

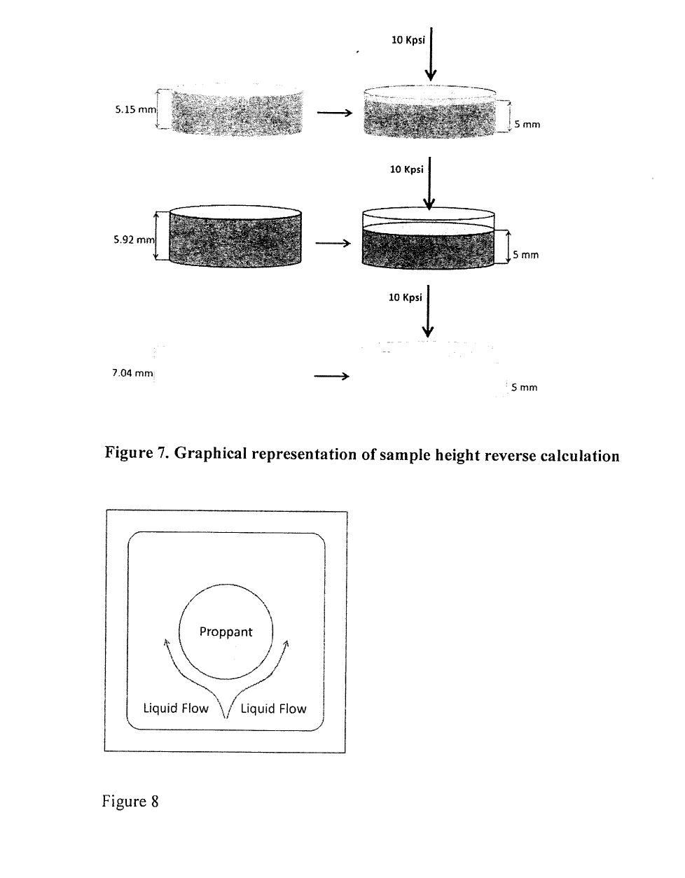

1. Equipment
1.1. Crush cell (will be refer as cell in the text below); e.g. ISO crush cell, described in ISO 13503-2:2006 (E) Section 11.3.2 FIG. 7
1.2. Press, able to provide required stress on a sample. Press should be modified with height gauge to measure distance between press rams
1.3. Height gauge (mentioned in Section 1.2), with resolution ±0.02 mm or better
1.4. Sampling equipment as per ISO 13503-2:2006 (E) Section 4.3
1.5. Lab balances, with resolution ±0.2 g or better
1.6. Lab vessels

2. Chemicals
2.1. Proppant for testing
2.2. DI water

3. Calibration procedure
3.1. Clean cell should be placed into press
3.2. Stress of 10±2 psi should be applied to empty cell operational area (area which will be occupied by sample)
3.3. Height gauge should be adjusted to 0.00±0.02 mm (reset indicator readings)
3.4. Pressure on the cell operational area should be increased gradually or in steps up to the pressure value at which pack height should be measured +1000 psi (e.g. if it is needed to measure sample height at 5300 psi, the pressure during calibration should be increased up to 6300 psi)
3.5. Height gauge readings (which are ≦0) can be recorded for example at following points: 10, 100, 500, 1000, the final stress value and between 1000 and final stress value with resolution of 1000 at least (e.g. 10, 100, 500, 1000, 2000, 3000, 4000, 5000, 6000, and 6300; if pressure at which sample height should be measured is 5300). Pressure values in this section are given on psi.
3.6. Calibration curve should be plotted in the height vs. stress dimensions. This curve describes “zero” system compaction: compaction of cell and press parts w/o sample

4. Sample preparation
4.1. Proppant sampling procedures should be carried out according ISO 13503-2:2006 (E) Section 4.5 or Section 4.6 with equipment described in ISO 13503-2:2006 (E) Section 4.3
4.2. Sample mass should be selected based on cell and press capabilities, but should not be less than 20.0 g

5. Testing procedure
5.1. Sample should be placed in the cell as per ISO 13503-2:2006 (E) Section 11.5.4
5.2. DI water should be carefully poured into the cell. Water level should be at least 2 cm higher above proppant placed into the cell
5.3. The cell with the sample covered with water should be kept intact for 15 min
5.4. Piston should be inserted as per ISO 13503-2:2006 (E) Section 11.5.5-11.5.6. Water should be allowed to leak out of the cell w/o applying any additional force
5.5. The cell with the piston and the sample should be placed into the press
   5.5.1. Calibration procedure should be carried out prior to this step as per Section 3
   5.5.2. Height gauge indication should be left intact since it was adjusted as per Section 3.3
5.6. Repeat steps described in Sections 3.2, 3.4 and 3.5 sequentially

6. Result processing
6.1. Plot testing data acquired in Section 5.6 as described in Section 3.6
6.2. Subtract height values from Section 3.6 to the height values from Section 6.1 at corresponding stresses. The resulting curve illustrates sample height change vs. effective stress on the sample

7. Data representation (examples)
7.1. Sample porosity at certain stress (φ^{p}). It can be calculated as follows (see FIG. 4 for details):

$${φ}^{p} = \frac{{V}^{void}}{{V}^{bulk}} = \frac{{V}^{sample} - {V}^{solid}}{{V}^{sample}} = \frac{{H}^{p} - {H}^{inf}}{{H}^{p}} = \frac{{H}^{p} - \frac{m}{ρ {S}^{sample}}}{{H}^{p}} = 1 - \frac{m}{ρ {H}^{p} {S}^{sample}} ; {S}^{sample} = Const \qquad Equation 1$$

Here H^{inf} is sample height at “infinite” pressure, which can be easily calculated by knowing sample mass (m), absolute density (ρ) and area occupied with sample (S^{sample}); H^{p} is sample height at certain pressure (data calculated in Section 6.2). In other H^{inf} words is height of sample fully composed of solids (i.e. φ for such sample is equal to zero). (Here the “infinite” only means that the sample is reorganized by such a way that there is no void space whatsoever among the grains; it is not implied that the sample absolute density is not dependent on the pressure, however, this dependence is neglected in this formula.) Equation 1 is deduced on the basis of equal surface occupied with sample for any stress (confined stress) and the change of cell area with pressure is neglected.
7.2. Relative height (\tilde{H}^{p}). Sample compaction can be measured as a ratio of sample height initial sample height as per Equation 2:

$${\tilde{H}}^{p} = \frac{{H}^{p}}{{H}^{0}} = \frac{{H}^{p} {ρ}_{b} {S}^{sample}}{m} ; {S}^{sample} = Const \qquad Equation 2$$

Here H^{p} is sample height at certain pressure (data calculated in Section 6.2), m is sample mass, S^{sample} is area occupied by sample, H⁰ is sample height when no stress is exerted on the sample, and ρ_{b} is sample bulk density. Equation 2 is deduced on the basis of equal surface occupied with sample for any stress (confined stress)

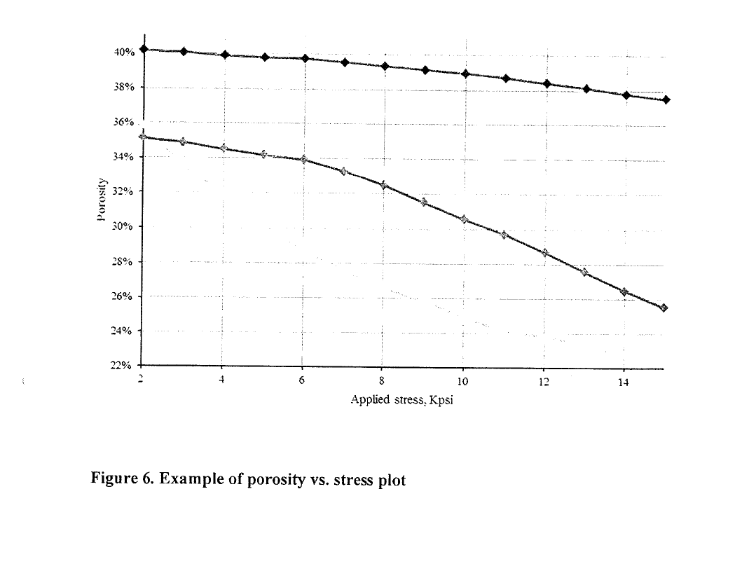

8. Data implementation
8.1. Both φ^{p} and \tilde{H}^{p} are dimensionless values and can be scaled up to a proppant pack of any size
8.2. For a correct scaling up process, the effective stress on the proppant pack in the fracture has to be known (at least to some extent)
8.3. Both φ^{p} and \tilde{H}^{p} can be used to calculate/estimate the compaction of the proppant pack under the certain stress; and to calculate the concentration of proppant required to be pumped to get desired fracture width
   8.3.1. For example, porosity vs. stress is measured for several materials as per Sections 5.6 and 7.1 (FIG. 5). The resulting sample height at certain stress can be calculated using Equation 1.
   8.3.2. However, inverse problem can be solved: if desired height is set, and required parameters are known (area occupied by the proppant pack, stress on the proppant pack and proppant absolute density), then the required mass of proppant can be calculated with help of Equation 1. On the FIG. 6, the results example of such reverse calculation is presented. Color coding is the same as for FIG. 5. Calculations are done for one unit of area, 10000 psi stress on the proppant pack, absolute densities are as follows: purple—3.5 g/cm³, red—2.7 g/cm³, ember—2.6 g/cm³.

9. Alternatives and modifications
9.1. Instead the cell described above (Section 1.1), one can use unconfined stress cell. Such cell implies the possibility of proppant sample to expand/spread under the stress. Height testing in such cell potentially can provide more accurate results for height measurements in case of HPP. A large cell provides more accurate results; in case if proppant pack diameter is less than 10 cm or height measurement are required for 3000 psi (or less) effective stress on the sample, the sample should not be tested by procedure described in Section 9.1. In case unconfined stress cell is used, following alteration to the procedure should be made:
   9.1.1. Calibration procedure (Section 3) and sampling procedure (Section 4) do not have to be changed
      9.1.1.1. However, hardened steel plate of the same area as the pillar in the cell can be used for calibration. The mechanical parameters of this plate should be known (measured in some certified laboratory). Its thickness change during calibration should be taken into consideration.
   9.1.2. Section 5.1—sample should be placed in the center of the cell operating area with help forming device (e.g. cast form) and forming agent (e.g. DI water). Forming agent should be used in minimal quantities to avoid premature sample spreading.
   9.1.3. Sections 5.2 and 5.3 should be omitted. Instead, the proppant sample can be kept in the vessel with forming agent for 15 min prior to sample loading into the cell
   9.1.4. Section 5.4 should be replaced with following steps: Piston should be carefully placed into the cell (with minimal additional force applied; no piston rotation/movement is required)
   9.1.5. Section 5.5 should be followed as described
   9.1.6. Section 5.6 should be replaced with following steps:

9.1.6.1. Characteristic stresses on the proppant pack have to be determined as described in Section 3.5
9.1.6.2. Separate test has to be performed for each stress
9.1.6.3. In addition to height and stress measurements, sample area has to be measured after each test
9.1.7. Results processing should be carried out according to Section 6. It is important to note, that calibration values acquired for stress on the call operational are in Section 9.1.1 must be matched with the values of stress exerted on the sample (Section 9.1.6.2), but not with values of stress exerted on cell operational area
   9.1.7.1. If the calibration was done according to Section 9.1.1.1, then compaction value from the experiment with the hardened steel plate should be subtracted from compaction value of pillar. An important reminder: area of the steel plate should be similar to resulting pillar area; stress exerted on the pillar and the steel plate should also be similar.
9.1.8. For data representation by Equation 1, sample are measured at the end of the test (Section 9.1.6.3) should be used as S^{sample}
9.1.9. For data representation by Equation 2 sample height measured at 10 psi should be used as H⁰. However, the approach of relative height (Section 7.2) is not recommended in case if unconfined stress cell is used
9.1.10. In addition to height measurements, spreading (change footprint) of the proppant pack can be measured. Pillar spreading for certain stress exerted on the proppant pack (Spreading) is ratio of pillar area at certain stress (S^{p}) to the pillar area at 10 psi (S¹⁰), see Equation 3:

$$Spreading = \frac{{S}^{p}}{{S}^{10}} \qquad Equation 3$$

9.2. DI water can be substituted for any other fluid (Sections 5.2 and 9.1.2). Ideally for testing procedure presented above the fluid with properties closest to treatment/flowback/reservoir fluid properties should be selected. Polarity and viscosity should be considered as the most important properties. In case if the results of height measurements are different, the worst case should be taken for further calculation

Characterizing Erosion Rate of Proppant Pack

Conductivity of the HPP fracture is higher than that of the conventional one because the flow passages for hydrocarbons (channels) remain open. This is so until the distance between pillars inside the fracture exceeds a critical length. Exceeding this length leads to channel closure and drop of HPP fracture conductivity. Thus, change of the pillar/channel geometry due to the erosion of proppant pillars during the flow-back and/or well production can affect fracture conductivity. In case of HPP treated fractures erosion of proppant pillars might have an impact on well production. Erosion of proppant pillars might lead to proppant back-production and drop of fracture conductivity. Thus, erosion measurement and characterization of its influence on well production is of importance for HPP treated wells.

Embodiments herein relate to proppant pack erosion measurement. The key point of the technique is to create scale independent fluid flow patterns, which allows us to collect experimental data, which would support modeling and simulating fluid flow through a channel or channeling network in the reservoir. This data can be used for: modeling input, proppant characterization and selection, well performance evaluation, or proof of reliable long-term performance of the well in some embodiments.

In some embodiments, proppant pack erosion measurements include the following: a proppant pillar placed in the testing environment as shown in FIG. 8 and exposed to testing conditions (fluid flow, stress, temperature etc.). FIG. 8 is a schematic representation of proppant loading for proppant pack erosion testing. The viewpoint is co-directional to direction of applied stress. The erosion measurements are based on collecting amount of washed out solids (usually in weight percent based on initial proppant pack mass) and plotting it against time of exposure to fluid flow, applied stress, flow rate etc. It is noteworthy, that such test configuration has several disadvantages: (i) measurement of fluid linear velocity is inadequate (fluid flow pattern significantly changes around the proppant pack); (ii) the fluid drag force applied to the proppant pack is changing along the pack-to-fluid contact area (as a consequence of (i)); (iii) erosion might be a scale affected phenomenon (changing erosion measurement setup dimensions and/or sample loading type/amount (even at similar test conditions) can affect the test results).

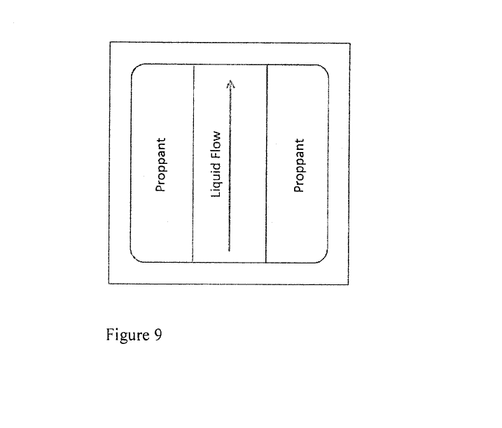

Alternative idea for test configuration (FIG. 9) is to simulate a fluid flow in the channel (it includes but not limited to fluid flow in the channels of HPP fracture). In such configuration, fluid flow behavior is almost independent of proppant pack size and which allows maintaining close-to-uniform flow pattern with clearly evaluated/estimated fluid linear velocity. For this, proppant should be put to the sides of the testing cell in order to leave the path for fluid flow between proppant packs completely open. Loading pattern can simulate not only one channel but also one-side loading (proppant is loaded only on side of testing cell), multiple channels (proppant is loaded in several “strips” orientated along the fluid flow) and/or angular loading (angle of proppant pack(s) loading is deviated from the fluid flow direction). FIG. 9 is a schematic representation of alternative proppant loading example for proppant pack erosion testing (viewpoint is co-directional to direction of applied stress).

As it can be seen in FIG. 9, using this erosion test configuration has several benefits: (i) fluid linear velocity can be estimated; (ii) drag force along the fluid-to-pack contact area is constant/uniform; (iii) test results are independent of setup and/or sample dimensions (as long as test conditions remain similar).

To obtain representative and repeatable results, the test procedure may include but is not limited to one or multiple following stages: (i) forming channel with dissoluble material (e.g. sugar, salt etc.) to keep initial dimensions of proppant pack(s) similar from test to test; (ii) forming proppant pack with binding agent (“forming” additive) (e.g. glycerol, polymeric gel, sugar syrup etc.) for the same purpose as in (i), (iii) forming channel and proppant pack with die-bar for the same purpose as in (i); (iv) installation of shields which prevent direct hitting of proppant pack with the fluid. If any chemicals are used to form channel and/or proppant pack, a pre-test procedure should carried out to ensure that this chemicals were washed out prior to the erosion data collection; on the other hand if for the test purpose erosion properties of proppant pack have to be tested in presence of chemicals, this condition is irrelevant.

General testing procedure is the following (some variations might occur depending on techniques described in previous paragraph) but not limited to:

1. Sample of desired composition should be prepared
1.1. Sample composition might vary from pure proppant to proppant with any chemicals (polymeric gel, fibers etc.)
   1.2. “Forming” additives should be added to the sample if needed (e.g. glycerol, polymeric gel, sugar syrup etc.)

2. Sample should be placed in erosion cell and shaped (if required) to form open channel (one-side loading/multiple channels/angular loading)
2.1. Glycerol (polymeric gel, sugar syrup etc.) can be used to give sample a desired shape
2.2. Sample could be loaded without any “forming” agents; area/volume occupied with sample can be restricted by forming a channel(s) with soluble material (sugar, salt etc.)
2.3. If no soluble material or “forming” additive is used, sample/channel can be given a desired shape using a die-bar.

3. Desired stress and fluid flow should be applied to the sample
3.1. If any compound is used to form a channel or to shape the sample is used, “initial” stage of fluid flow can be implemented (if required) to remove/wash out this compound
3.2. During the “initial” stage additional effects can be simulated:
   3.2.1. Gel break
   3.2.2. Fibers degradation
   3.2.3. Partial sample dissolution
3.3. “Initial” stage should be performed at flow rate low enough not to cause sample erosion
3.4. Depending on experimental needs stress can be applied either before or after “initial” stage
   3.4.1. Stress can be exerted on using:
      3.4.1.1. Steel plates
      3.4.1.2. Formation rock cores
      3.4.1.3. Other metallic, ceramic or plastic insertions
   3.4.2. Embedment of proppant pack into compressing surfaces can be taken into account (contribute to proppant pack height) if needed
3.5. Effects described in 3.2 can be simulated not only at the “initial” stage but also during the experiment depending on test goals

4. Sample erosion should be measured
4.1. Sample (proppant pack) height should measured during the experiment
4.2. Flow rate should be adjusted depending on experiment goal
4.3. Time of test should be designed according to experimental needs
4.4. Washed out solids should be collected to measure sample erosion
4.5. Mass of residual solids should be measured

5. Fluid linear velocity should be calculated
5.1. One (not limiting) of the approaches to calculate fluid linear velocity is following: The resulting sample size is measured after the test is completed. It is assumed that no sample spreading occurs at test conditions. In this case reduction in sample area is proportional to the amount of washed out solids (eq. 5). Using this approach, sample area as well as channel cross-section can be back-calculated to any point when sample mass/amount of washed out solids is measured. Fluid linear velocity can be calculated as quotient of flow rate and channel cross-section. Channel cross-section is calculated as difference between cell operating area breadth and sample breadth multiplied by sample height.

$$S = {S}^{end} \frac{m}{{m}^{end}} = {S}^{end} ( 1 + \frac{Δ m}{{m}^{end}} ) \qquad eq . 5$$

Here S and m are sample area and mass at the moment when eroded solid were started being collected, S^{end} is resulting sample area, m^{end} is resulting sample mass and Δm is mass of washed out solids collected in the considered time period.

One (not limiting) of possible representation of such test results is plotting the eroded mass (g) normalized to fluid-to-pack contact area (cm²) and time (s). This normalized erosion rate (g/[s*cm²]) can then be plotted against the linear fluid velocity. Alternatively, the eroded mass is normalized with the contact area first and then this normalized value is plotted against the time at a constant linear velocity of the fluid. In the second step, it can be further normalized with the time by determining the slope of the curve. This latter introduced two-step procedure should lead to the results introduced initially. Results represented this way can be: (i) used as a specific proppant characteristic; (ii) scaled up regardless of system size; (iii) implemented to computation models and software; (iv) applied for job design of HPP treatment; (v) used for easy data presentation.

Extension of (iv): One of the erosion test results is the value of critical erosion velocity, below which no erosion occurs. This value can be used as input data to fracture design software to calculate the recommended maximum production/flowback rate for particular well to avoid pillar erosion.

We claim:

1. A method for processing a subterranean formation traversed by a wellbore, comprising:
identifying proppant characteristics;
forming a fluid using the proppant and proppant characteristics;
observing the proppant in the fluid wherein the fluid has phases of high concentration and low concentration of proppant; and
introducing the fluid into the wellbore.

2. The method of claim 1, wherein the observing comprises measuring or estimating or both proppant pack settling.

3. The method of claim 1, wherein the observing comprises proppant pack compaction.

4. The method of claim 1, wherein the observing comprises characterizing an erosion rate of a proppant pack.

5. The method of claim 1, wherein the identifying proppant characteristics comprises absolute density, mesh size distribution, proppant mean diameter, proppant bulk density, or a combination thereof.
